(19) United States
(12) Patent Application Publication
(10) Pub. No.: US 2026/0027924 A1
(43) Pub. Date: Jan. 29, 2026

(54) CHARGING BOX

(71) Applicant: ISUZU MOTORS LIMITED, Yokohama-shi (JP)

(72) Inventors: Hitoshi NISHITANI, Fujisawa-shi (JP); Hideo TSUTSUMI, Fujisawa-shi (JP); Yoshinori GODO, Fujisawa-shi (JP)

(21) Appl. No.: 19/252,555

(22) Filed: Jun. 27, 2025

(30) Foreign Application Priority Data
Jul. 25, 2024 (JP) 2024-120401

(51) Int. Cl. B60L 53/16; B60L 53/302; B60R 16/023

(52) U.S. Cl. CPC B60L 53/16; B60L 53/302; B60R 16/0238; B60R 16/0239

(57) ABSTRACT

A charging box includes: a charging section that can be connected with a connector of an external power supply apparatus; a housing that internally houses electric wires connected with the charging section; and a connecting member that connects the electric wires with electric wires that are exposed to the outside of the housing, and are connected with an apparatus on the side of the vehicle body. The connecting member is provided to a housing upper surface, which becomes the upper surface in the vertical direction when the connecting member is attached to the vehicle body.

### CROSS-REFERENCE TO RELATED APPLICATIONS

The present application claims priority to Japanese Patent Applications number 2024-120401, filed on Jul. 25, 2024 contents of which are incorporated herein by reference in their entirety.

### BACKGROUND OF THE INVENTION

The present invention relates to a charging box of a vehicle.

Vehicles are provided with a box-shaped charging box that charges a battery by a charging gun connected thereto (see Japanese Patent Application Publication No. 2019-84973). The charging box has a charging port, and a housing that houses an electric wire (hereinbelow, called a first electric wire) connected with the charging port.

There is a proposed charging box having a connecting member that connects a first electric wire with a second electric wire connected to an apparatus of a vehicle, and is provided outside the housing. In a case where the connecting member is positioned outside the housing, there is a fear that water enters the connecting member. If water enters the connecting member, the function of the connecting member is impaired undesirably.

### BRIEF SUMMARY OF THE INVENTION

The present invention has been made in view of these matters, and an object thereof is to suppress the impairment of the function of a connecting member provided outside the housing of a charging box.

One aspect of the present invention provides a charging box that is attached to a vehicle body, and can receive power from an external power supply apparatus, the charging box including: a charging section that can be connected with a connector of the external power supply apparatus; a housing that internally houses a first electric wire connected with the charging section; and a connecting member that connects the first electric wire with a second electric wire that is exposed to an outside of the housing, and is connected with an apparatus on a side of the vehicle body, in which the connecting member is provided to a housing upper surface which becomes an upper surface in a vertical direction when the connecting member is attached to the vehicle body.

### BRIEF DESCRIPTION OF THE DRAWINGS

FIG. 1 is a side view of a vehicle 1 on which a charging box 10 according to one embodiment is mounted.

FIG. 2 is a schematic diagram depicting an example of equipment provided to an equipment room 3.

FIG. 3 is a schematic diagram depicting the charging box 10.

FIG. 4 is a schematic diagram depicting a charging box 110 according to a comparative example.

FIG. 5 is a figure for explaining water flowing along electric wires 8.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Summary of Vehicle>

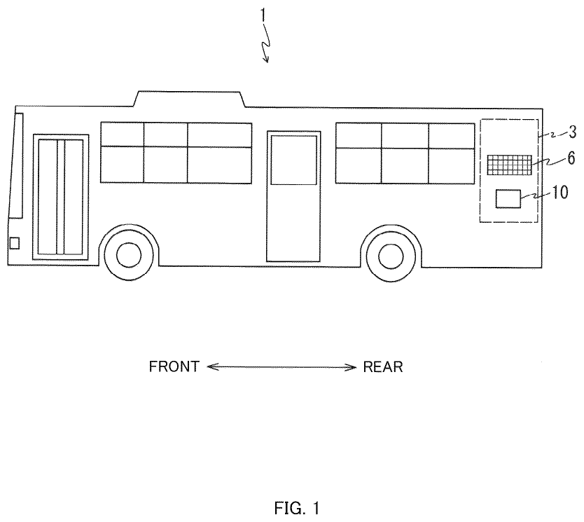

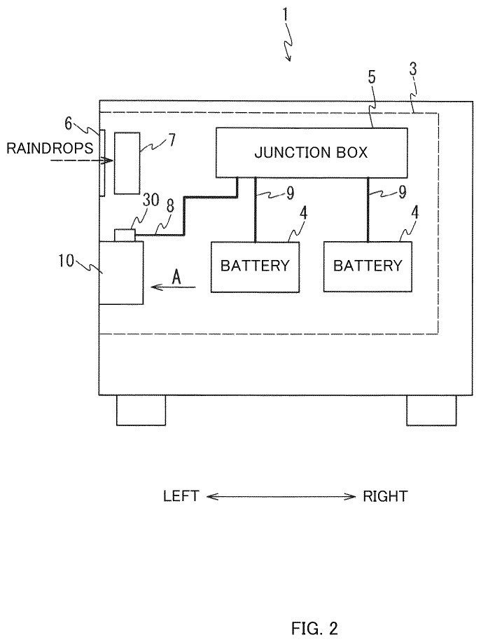

A summary of a vehicle 1 on which a charging box according to one embodiment is mounted is explained with reference to FIG. 1 and FIG. 2.

FIG. 1 is a side view of the vehicle 1 on which a charging box 10 according to one embodiment is mounted. FIG. 2 is a schematic diagram depicting an example of equipment provided to the equipment room 3. For example, the vehicle 1 is an electric vehicle that can travel using a motor. Whereas the vehicle 1 is a bus as depicted in FIG. 1 here, this is not the sole example, and the vehicle 1 may be a truck, for example.

The vehicle 1 has the equipment room 3 positioned at the rear of the vehicle body. The equipment room 3 is positioned behind the passenger compartment of the vehicle 1. The equipment room 3 has a space that houses equipment for driving the vehicle 1 using the motor. As depicted in FIG. 2, the equipment room 3 is provided with batteries 4, a junction box 5, a ventilation port 6, and the charging box 10.

The batteries 4 are secondary batteries that can be charged repeatedly. A plurality of the batteries 4 are provided here. For example, the batteries 4 supply electricity to the motor to thereby drive the motor, and cause the vehicle 1 to travel.

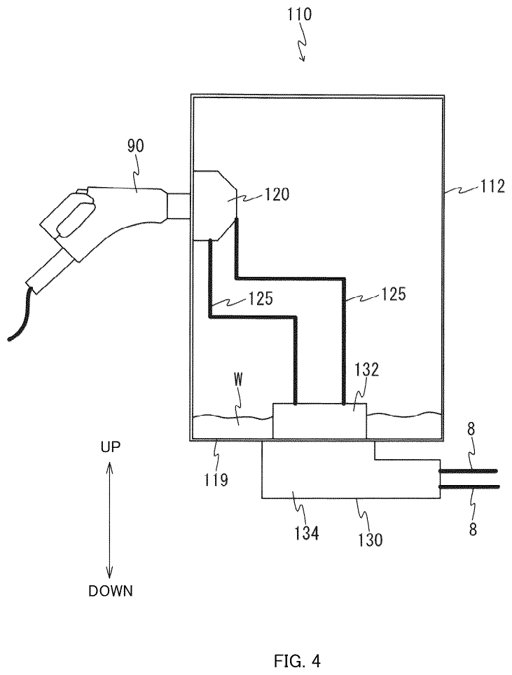

The charging box 10 is an apparatus that can receive power from an external power supply apparatus. Specifically, the charging box 10 charges the batteries 4 of the vehicle 1 with electricity supplied via a connector (specifically, a charging gun 90 depicted in FIG. 4) of the external power supply apparatus. As depicted in FIG. 1, the charging box 10 is provided to a side surface at the rear (specifically, the equipment room 3) of the vehicle 1.

The junction box 5 is provided between the charging box 10 and the batteries 4. For example, the junction box 5 has a function to distribute, to each the plurality of batteries 4, electricity externally supplied via the charging box 10. The junction box 5 is connected with a connecting member 30 of the charging box 10 by electric wires 8, and is connected with the batteries 4 by electric wires 9. The connecting member 30 is positioned at the top of the charging box 10. Each of the electric wires 8 and the electric wires 9 is a wire harness here. Note that whereas, for convenience of explanation, each of the electric wires 8 and the electric wires 9 is depicted using one line in FIG. 2, it is actually a pair of electric wires connected to a positive terminal and a negative terminal.

The ventilation port 6 is an opening for taking in external air into the equipment room 3. As an example, a mesh-like member that allows the passage of external air therethrough is attached to the ventilation port 6. As depicted in FIG. 1, the ventilation port 6 is positioned above the charging box 10 on the side surface of the equipment room 3. The ventilation port 6 takes in external air that heads toward an air-cooling type radiator 7 provided inside the equipment room 3. The radiator 7 cools a refrigerant or the like using the air from the ventilation port 6. The radiator 7 is at such a position that the radiator 7 faces the ventilation port 6, and is positioned above the charging box 10.

Meanwhile, as depicted in FIG. 2, water (e.g. raindrops) enters from the ventilation port 6 in some cases. The water having entered from the ventilation port 6 falls on the charging box 10 (specifically, the connecting member 30) positioned below the ventilation port 6 in the equipment room 3. Then, if the water, which is a conductor, is kept in contact with the connecting member 30 of the charging box 10, there is a fear that the insulation resistance of the connecting member 30 lowers undesirably, and the function of the connecting member 30 is impaired.

In contrast, the charging box 10 of the present embodiment has an attachment structure for the connecting member 30 for suppressing the impairment of the function of the connecting member 30 caused by water having entered from the ventilation port 6.

### <Configuration of Charging Box>

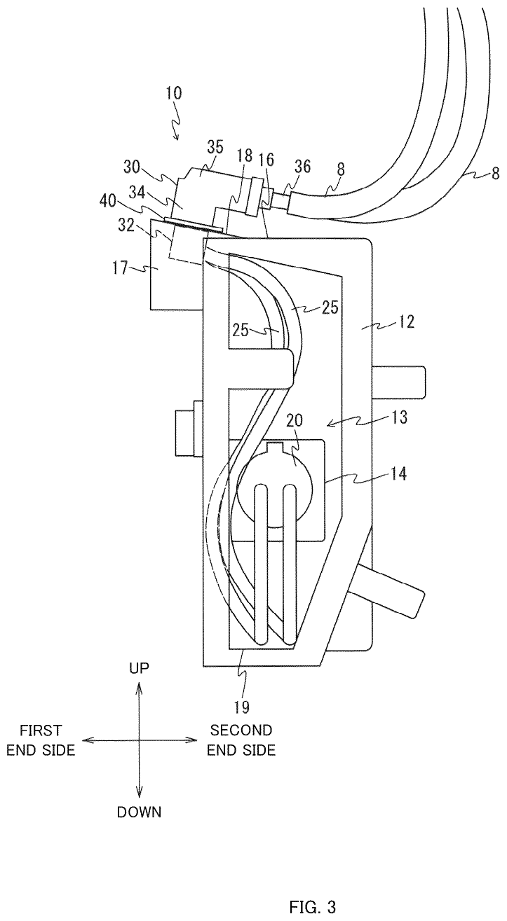

FIG. 3 is a schematic diagram depicting the charging box 10. FIG. 3 depicts the charging box 10 as seen in the direction of an arrow A in FIG. 2 (i.e. the charging box 10 seen from the rear surface side). Note that a lid member covering a rear opening 13 of a housing 12 is omitted in FIG. 3 in order to depict the internal configuration of the charging box 10.

The charging box 10 has the housing 12, a charging section 20, electric wires 25, the connecting member 30, and an attachment section 40.

The housing 12 is a box with a rectangular parallelepiped shape. The housing 12 is attached to a side surface of the vehicle 1 having the ventilation port 6 provided at an upper portion thereof. The front surface of the housing 12 is on the farther side of the paper surface of FIG. 3, and the rear surface of the housing 12 is on the nearer side of the paper surface of FIG. 3. The housing 12 has a housing space that internally houses the electric wires 25. The charging section 20 is attached to a front panel 14 positioned on the front surface side of the housing 12. The rear surface side of the housing 12 is fixed to the vehicle body (equipment room 3) by a fastening member.

The charging section 20 is provided in the housing 12, and has a charging port that can be connected with the charging gun 90 (see FIG. 4). The charging port is a connector portion which is an insertion port for the charging gun 90. The charging section 20 is provided such that the charging port is exposed through the front panel 14 of the housing 12. Note that the charging box 10 has an opening/closing door that can block the charging port. The charging section 20 is positioned at the middle of the front panel 14 of the housing 12.

The electric wires 25 link the charging section 20 and the connecting member 30. First ends of the electric wires 25 are connected with the charging section 20, and second ends of the electric wires 25 are connected with the connecting member 30 of the charging section 20. The electric wires 25 are wire harnesses here, and are provided in a pair. The pair of electric wires 25 are arranged to be adjacent inside the housing 12. One of the pair of electric wires 25 is connected with the positive terminal of the charging section 20, and the other of the pair of electric wires 25 is connected with the negative terminal of the charging section 20.

The connecting member 30 connects the electric wires 25 with the electric wires 8 that are exposed to the outside of the housing 12, and are connected with an apparatus (specifically, the junction box 5 depicted in FIG. 2) on the side of the vehicle body. That is, the connecting member 30 connects the pair of electric wires 25 in the housing 12 and a pair of the electric wires 8 positioned outside the housing 12. Thereby, electricity received by the charging section 20 is supplied to the junction box 5 through the electric wires 25 and the electric wires 8. The connecting member 30 is provided to a housing upper surface 16, which becomes the upper surface in the vertical direction when the connecting member 30 is attached to the vehicle body. In the present embodiment, the electric wires 25 correspond to the first electric wire, and the electric wires 8 correspond to the second electric wire.

The connecting member 30 has a socket 32 and a plug 34 that are fitted to each other.

The socket 32 is positioned in the housing 12, and is connected with the pair of electric wires 25. The socket 32 is positioned inside an extending section 17 extending from the top of the housing 12 to a first end side in the widthwise direction. The socket 32 is fixed to the extending section 17.

The plug 34 is exposed to the outside of the housing 12. The plug 34 is fitted to the socket 32 in a state where the plug 34 is positioned outside the housing 12, and is connected with the electric wires 8. The plug 34 is positioned on the upper side of the attachment section 40, and is fitted to the socket 32 with the attachment section 40 being interposed therebetween. The plug 34 can be attached to and removed from the socket 32. Note that a sealing member is provided to the inside of at least one of the socket 32 and the plug 34.

The attachment section 40 is a portion where the connecting member 30 is attached. The attachment section 40 is provided to the top of the housing 12. In the present embodiment, the connecting member 30 is attached to the attachment section 40 by the socket 32 being fitted to the plug 34 fixed to the attachment section 40.

The attachment section 40 is positioned at the top of the extending section 17. The upper surface of the extending section 17 forms part of the housing upper surface 16 of the housing 12. Because of this, the attachment section 40 is provided to the housing upper surface 16.

The upper surface of the extending section 17 is an inclined surface 18 inclined at a predetermined angle (e.g. 15 degrees to 30 degrees) to the horizontal plane. In other words, the housing upper surface 16 includes the inclined surface 18. The inclined surface 18 is positioned at a first end of the housing upper surface 16 in the widthwise direction. The connecting member 30 is attached to the inclined surface 18. Specifically, the plug 34 of the connecting member 30 is positioned on the inclined surface 18. In the present embodiment, the width direction of the housing upper surface 16 corresponds to the predetermined direction.

Since the connecting member 30 is provided to the housing upper surface 16 (in particular, the inclined surface 18), the accumulation of water having fallen from the ventilation port 6 around the connecting member 30 can be suppressed. Hereinbelow, further explanations are given in comparison with a comparative example depicted in FIG. 4.

FIG. 4 is a schematic diagram depicting a charging box 110 according to the comparative example. In the comparative example, a connecting member 130 is attached to a lower surface 119 of a housing 112. The connecting member 130 has: a socket 132 positioned in the housing 112; and a plug 134 positioned outside the housing 112. The socket 132 is fixed to the lower surface 119 of the housing 112, and is connected with a charging section 120 by electric wires 125.

Water having entered from the ventilation port 6 mentioned before falls onto the charging box 110. Part of the water having fallen onto the charging box 110 enters the housing 112 through a gap of the housing 112, and accumulates on the lower surface 119 as depicted in FIG. 4 (the portion denoted by a reference character W in FIG. 4). The socket 132 fixed to the lower surface 119 is kept in contact with the water that has accumulated on the lower surface 119. If water, which is a conductor, is in contact with the socket 132, the insulation resistance of the socket 132 lowers undesirably. In addition, if water enters and accumulates in the socket 132, a sealing member inside the socket 132 is degraded undesirably, and, for example, the water resistance of the connecting member 130 is impaired.

In contrast, in a case where the connecting member 30 is provided to the housing upper surface 16 as in the present embodiment, water having fallen from the ventilation port 6 is unlikely to accumulate on the housing upper surface 16, and accordingly it is possible to prevent the socket 32 and the plug 34 of the connecting member 30 from being kept in contact with the water. Thereby, the lowering of the insulation resistance of the connecting member 30 and the degradation of the sealing member caused by the water can be suppressed. In particular, in a case where the connecting member 30 is attached to the inclined surface 18 of the housing upper surface 16, the water having fallen from the ventilation port 6 flows along the inclined surface 18, and accordingly the accumulation of the water around the connecting member 30 can be prevented.

Note that part of the water having fallen from the ventilation port 6 can enter the housing 12, and accumulate on a lower surface 19 of the housing 12; however, since the connecting member 30 is not provided on the lower surface 19, the impairment of the function of the connecting member 30 caused by the water can be prevented.

Next, the detailed configuration of the plug 34 positioned outside the housing 12 is explained. As depicted in FIG. 3, the plug 34 has a main body 35 and connection protrusions 36.

The main body 35 is a portion forming the frame of the plug 34. The main body 35 is positioned on a first end side of the housing upper surface 16 in the widthwise direction. The main body 35 is formed in an L-shape here. At its portion in contact with the housing upper surface 16, the main body 35 has a fitting section that is fitted to the socket 32.

The connection protrusions 36 are portions protruding from the main body 35, and are connected with the electric wires 8. Two connection protrusions 36 are provided such that each of them is connected with one of the two electric wires 8. The connection protrusions 36 protrude from a first end of the main body 35 along the housing upper surface 16. Specifically, the connection protrusions 36 protrude on the housing upper surface 16 toward a second end in the widthwise direction. In this case, the plug 34 connected with the electric wires 8 can be arranged in a limited space of the housing upper surface 16 in the widthwise direction.

The connection protrusions 36 are connected with curved ends of the electric wires 8 positioned above the housing 12. Since the ends of the electric wires 8 are curved, water having fallen onto the electric wires 8 from the ventilation port 6 is unlikely to reach the connection protrusions 36 even if the water flows along the electric wires 8. Because of this, the entrance of the water having fallen onto the electric wires 8 from the ventilation port 6 into the connecting member 30 (specifically, the plug 34) can be suppressed.

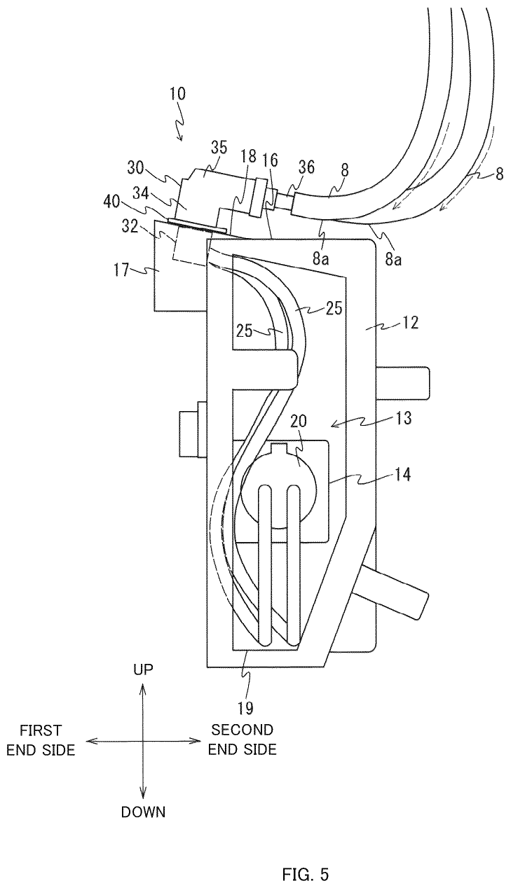

FIG. 5 is a figure for explaining water flowing along the electric wires 8. The connection protrusions 36 protrude obliquely downward from the main body 35.

Specifically, the connection protrusions 36 are parallel to the inclined surface 18. In this case, lower parts 8a that are positioned at the lowest portions, in the up-down direction, of the curved ends (here, ends curved in U-shapes) of the electric wires 8 are likely to be positioned below the connection protrusions 36. In this case, water having fallen onto the electric wires 8 from the ventilation port 6 stays at the lower parts 8a of the second electric wires, and is unlikely to reach the connection protrusions 36 even if the water flows along the electric wires 8 in the directions of broken-line arrows depicted in FIG. 5. Thereby, the entrance of the water having fallen from the ventilation port 6 into the plug 34 can be suppressed.

### Modification Example

Note that whereas it is assumed in the description above that the connecting member 30 is attached to the inclined surface 18 of the housing upper surface 16, this is not the sole example. For example, the connecting member 30 may be attached to an uninclined surface of the housing upper surface 16. In this case, the connection protrusions 36 of the connecting member 30 is parallel to the housing upper surface 16. With the configuration also, water is unlikely to accumulate on the surface where the connecting member 30 is attached, and accordingly the entrance of water into the connecting member 30 can be suppressed.

### Effects of Present Embodiment

The charging box 10 according to the embodiment mentioned above includes: the housing 12 that internally houses the electric wires 25 connected with the charging section 20; and the connecting member 30 that connects the electric wires 25 with the electric wires 8 that are exposed to the outside of the housing 12, and are connected with the junction box 5. Then, the connecting member 30 is provided to the housing upper surface 16, which becomes the upper surface in the vertical direction when the connecting member 30 is attached to the vehicle body.

In the case of the configuration, water is unlikely to accumulate around the connecting member 30, and accordingly it is possible to prevent the connecting member 30 from being kept in contact with water. Thereby, the lowering of the insulation resistance of the connecting member 30 and the degradation of the connecting member 30 caused by water (specifically, the degradation of the sealing member caused by water having entered the connecting member 30) can be suppressed. As a result, the impairment of the function of the connecting member 30 can be suppressed.

Whereas the present invention has been explained using embodiments thus far, the technical scope of the present invention is not limited by the scope described in the embodiments described above, but various modifications and changes are possible within the scope of a gist of the present invention. For example, all or some of apparatuses can be configured functionally or physically distributed or integrated in any units. In addition, new embodiments that are generated by any combination of a plurality of embodiments are also included in embodiments of the present invention. Effects of the new embodiments generated by the combination combine effects of the original embodiments.

1. A charging box that is attached to a vehicle body, and can receive power from an external power supply apparatus, the charging box comprising:
a charging section that can be connected with a connector of the external power supply apparatus;
a housing that internally houses a first electric wire connected with the charging section; and
a connecting member that connects the first electric wire with a second electric wire that is exposed to an outside of the housing, and is connected with an apparatus on a side of the vehicle body, wherein
the connecting member is provided to a housing upper surface which becomes an upper surface in a vertical direction when the connecting member is attached to the vehicle body.

2. The charging box according to claim 1, wherein
the housing upper surface has an inclined surface inclined to a horizontal plane, and
the connecting member is provided to the inclined surface.

3. The charging box according to claim 2, wherein
the connecting member has: a main body; and a connection protrusion that protrudes from the main body, and is connected with the second electric wire, and
the connection protrusion protrudes obliquely downward from the main body.

4. The charging box according to claim 3, wherein the connection protrusion is connected with a curved end of the second electric wire positioned above the housing.

5. The charging box according to claim 3, wherein
the inclined surface is positioned at a first end of the housing upper surface in a predetermined direction, and
the connection protrusion protrudes toward a second end in the predetermined direction.

6. The charging box according to claim 3, wherein the connection protrusion is parallel to the inclined surface.

7. The charging box according to claim 1, wherein
the connecting member has: a main body; and a connection protrusion that protrudes from the main body, and is connected with the second electric wire, and
the connection protrusion is parallel to the housing upper surface.

8. The charging box according to claim 1, wherein
the connecting member has:
a socket that is positioned in the housing, and is connected with the first electric wire; and
a plug that is fitted to the socket in a state where the plug is positioned outside the housing, and is connected with the second electric wire.

9. The charging box according to claim 1, wherein the housing is attached to a side surface of the vehicle body having a ventilation port provided at an upper portion thereof.
